(19) United States
(12) Patent Application Publication
(10) Pub. No.: US 2008/0172256 A1
(43) Pub. Date: Jul. 17, 2008

(54) METHOD FOR FINANCING A PROVIDER OF ENERGY TO A UTILITY

(76) Inventor: Barak Yekutiely, Kochav Yair (IL)

Correspondence Address: David Klein;DEKEL PATENT LTD., Beit HaRof'im, 18 Menuha VeNahala Street, Room 27, REHOVOT, omitted

(21) Appl. No.: 11/622,042

(22) Filed: Jan. 11, 2007

(51) Int. Cl. G06Q 40/00; G06Q 10/00

(52) U.S. Cl. 705/4; 705/38; 705/30

(57) ABSTRACT

A method for financing a provider of energy to a utility, the method including creating a financial instrument belonging to an energy provider, which includes an asset-backed security (ABS), the ABS being backed by non-mortgage assets and the energy provider being part of a corporation, issuing and selling the ABS to an investor, and protecting the investor from possible bankruptcy of the energy provider by:

a. defining any transfer of assets from the energy provider as a non-recourse, true sale,

b. giving the investor a perfected interest in the asset cash flows of the energy provider, and

c. obtaining a non-consolidation legal opinion certifying that assets of the energy provider cannot be consolidated with assets of the corporation in the event of bankruptcy.

### FIELD OF THE INVENTION

The present invention relates generally to methods for financing a provider of energy to a utility, for example, a provider of solar generated electrical power, generated by a photovoltaic covering over a body of water.

### BACKGROUND OF THE INVENTION

Photovoltaic (PV) technology available on the market today basically includes two commercial module technologies:

1. Thick-crystal products include solar cells made from crystalline silicon either as single or poly-crystalline wafers and deliver about 10-12 watts per ft² of PV array (under full sun).

2. Thin-film products typically incorporate very thin layers of photovoltaic active material placed on a glass superstrate or a metal substrate using vacuum-deposition manufacturing techniques similar to those employed in the coating of architectural glass. Presently, commercial thin-film materials deliver about 4-5 watts per ft² of PV array area (under full sun). Thin-film technologies hold out the promise of lower costs due to much lower requirements for active materials and energy in their production when compared to thick-crystal products.

A photovoltaic system is constructed by assembling a number of individual collectors called modules electrically and mechanically into an array.

Building Integrated Photovoltaics (BIPV) is the integration of photovoltaic cells into a building envelope. The PV modules serve the dual function of building skin-replacing conventional building envelope materials-and power generator. By avoiding the cost of conventional materials, the incremental cost of photovoltaics is reduced and its life-cycle cost is improved. That is, BIPV systems often have lower overall costs than PV systems requiring separate, dedicated, mounting systems.

A complete BIPV system may typically include:

a. the PV modules (which might be thin-film or crystalline, transparent, semi-transparent, or opaque);

b. a charge controller, to regulate the power into and out of the battery storage bank (in stand-alone systems);

c. a power storage system, generally comprised of the utility grid in utility-interactive systems or, a number of batteries in stand-alone systems;

d. power conversion equipment including an inverter to convert the PV modules' DC output to AC compatible with the utility grid;

e. backup power supplies such as diesel generators (optional-typically employed in stand-alone systems); and

f. appropriate support and mounting hardware, wiring, and safety disconnects.

Starting a company in the energy technology industry generally requires an enormous capital investment. The risks are high and there are many factors that affect success, some of which have nothing to do with the technology. For example, two non-technological factors are the regulatory environment (government regulations and bureaucracy) and the ability to convince the energy utility of the idea's attractiveness.

For example, for most start-up companies, investors are looking for a product to be introduced into the market within one to three years. However, in the energy generation business, this timeline is rarely possible (if at all) if the company is selling to a utility customer. Typically a year passes by until a public utility company can certify the technology, and then it takes another one to two years just to complete the pilot program. Even after approval of the pilot program, the technology is still not yet available for the marketplace because a requests-for-proposal process must be carried out. One of the reasons is that public utilities are quasi-government-regulated entities, so a competitive bid process is required and can add another six months to a year. Thus, the timelines for selling to utilities significantly hurt the ability of small start-up companies in the energy technology industry to generate the needed capital from investors to survive.

### SUMMARY OF THE INVENTION

The present invention seeks to provide methods for financing a provider of energy to a utility, for example, a provider of solar generated electrical power, generated by a photovoltaic covering over a body of water, as is described more in detail hereinbelow.

In one embodiment of the present invention, the energy is provided by WIPV (Water Integrated Photovoltaic) Technology/Systems. WIPV technology/systems/installations have the following advantages:

1. Protect precious clean water sources from evaporation by using a WIPV floating solar cover made of prefabricated or field-installed geomembrane and solar cells and/or modular interconnected solar cells (flexible or other and modularly connected using interconnecting elements) that float or are buoyant and have direct contact with the water body.

2. Large scale efficient energy creation system/power plant using any type of water surface area as opposed to expensive land area.

3. Large scale efficient water creation, water delivery, water rehabilitation, water treatment system without requiring any onsite energy.

4. Substantial increase of solar energy compared to non-WIPV solar array installations due to constant water cooling of solar cells from water bodies.

5. Very environmentally friendly green technology (blends in perfectly with the environment) unlike solar arrays and wind turbines that are visible and interfere with the environment

Other Advantages of WIPV Type Installations/Systems:

Water bodies not only cool the solar cells, but also can be used for cleaning the solar cells from dust/dirt. The WIPV cells can be used as a natural solar concentrator because they can be immersed or be buoyant at a water level for maximum solar radiation. Alternatively for a floating WIPV installation, water can be sprayed on the panel creating millions of magnifying glasses that increase the solar radiation and concentrate the suns rays on the solar material.

WIPV can be adapted to function in other industries such as gas creation, land fills, etc. The WIPV concept can be used in a great variety of applications, such as but not limited to, WIPV Power Plant, WIPV Water Plant, WIPV water channel, WIPV water pipe, WIPV reservoir, WIPV gas collection/power system, WIPV desalination plant, WIPV irrigation system, WIPV pumping system, WIPV water delivery system, WIPV open water desalination plant, WIPV water treatment plant, WIPV Maritime Energy System, WIPV maritime mobile water desalination system, WIPV maritime national border defense system, WIPV bridge, or WIPV water transportation system.

Simply stated, the WIPV systems and methods of the present invention harness two key natural resources: vast surface areas of water bodies (e.g., large water reservoirs), and solar radiation. The WIPV systems and methods of the present invention address sustainable management of natural resources in several key ways:

Generation of renewable solar energy and benefit from policy and tariff incentives/premiums

Conserving water resources by preventing loss from excessive evaporation

Maintaining safe and secure water supplies with protection form various forms of contamination

Useful option in abatement of climate change due to reduction in natural green house gas emissions from water vapour

Some of the significant advantages of the WIPV systems and methods of the present invention may be appreciated by the fact that the total surface area of global surface water reservoirs (covered and uncovered) is currently estimated by UNESCO to be 600,000 km² with an estimated potential annual solar energy production capacity of 60,000 GW/H.

There is thus provided in accordance with an embodiment of the present invention a method for financing a provider of energy to a utility, the method including creating a financial instrument belonging to an energy provider, which includes an asset-backed security (ABS), the ABS being backed by non-mortgage assets and the energy provider being part of a corporation, issuing and selling the ABS to an investor, and protecting the investor from possible bankruptcy of the energy provider by:

a. defining any transfer of assets from the energy provider as a non-recourse, true sale,

b. giving the investor a perfected interest in the asset cash flows of the energy provider, and

c. obtaining a non-consolidation legal opinion certifying that assets of the energy provider cannot be consolidated with assets of the corporation in the event of bankruptcy.

The method may further include issuing the financial instrument in conjunction with an ALOP (advanced loss of profit) insurance wrapper, which insures revenue from projects under construction. The ALOP may be provided by an insurance company. The energy provider may become owner of assets associated with the ABS following maturity of the financial instrument. The corporation may remove assets associated with the ABS from a balance sheet of the corporation. The corporation may service assets associated with the ABS, the servicing being funded by cash flows of the assets associated with the ABS.

In accordance with a particular embodiment of the present invention, the energy provider provides solar generated electricity that is generated by a WIPV (Water Integrated Photovoltaic) energy generating system. The financial instrument may include an exclusive option for the WIPV provider to cover a water surface area in return for energy derived therefrom. The WIPV provider may provide a long-term product warranty on a material used to cover the water surface area, a long-term power performance guarantee, or a long-term energy purchase contract, for example.

### DETAILED DESCRIPTION OF EMBODIMENTS

There is provided in accordance with an embodiment of the present invention, a system including a plurality of interconnected photovoltaic cells covering at least a portion of a body of water, wherein some or all of the photovoltaic cells have a solar collecting surface covered by the water.

The solar collecting surface of some or all of the photovoltaic cells may be submerged in the water. Additionally or alternatively, a pump may be provided that sprays water on the solar collecting surface of some or all of the photovoltaic cells. The water that covers the solar collecting surface of some or all of the photovoltaic cells may magnify the solar rays impinging through the water on to the solar collecting surface.

In accordance with an embodiment of the present invention, some or all of the photovoltaic cells may be pivotally mounted on pivots. One or more actuators (e.g., inflatable membrane, cams, step motors, servomotors, etc.) may be in operative communication with the pivotally mounted photovoltaic cells and may tilt the pivotally mounted photovoltaic cells. A sensor may be provided that senses an impinging angle of the sun and this sensor may be in operative communication with the actuator(s) for tilting the pivotally mounted photovoltaic cells in accordance with the impinging angle of the sun sensed by the sensor. In addition, the whole WIPV array of interconnected photovoltaic cells may be rotated and controlled automatically to follow the angle of the sun's arc by using automatic tensioners (such as that described in U.S. Pat. No. 6,893,005, the disclosure of which is incorporated herein by reference) to further increase the annual power output. The inflatable membranes may control the buoyancy and level of the photovoltaic cells for optimum operation, such as for achieving the best power under varying environmental and operational factors (e.g., solar direction/angle, wind, reservoir level, desired tension and stability for walking on the panels for maintenance, etc.).

Some or all of the photovoltaic cells may be flexibly mounted to one another.

An electrical energy power device may be energized by electricity generated by the photovoltaic cells, thereby creating a WIPV (Water Integrated Photovoltaic) system. The WIPV concept can be used in a great variety of applications, such as but not limited to, WIPV Power Plant, WIPV Water Plant, WIPV water channel, WIPV water pipe, WIPV reservoir, WIPV desalination plant, WIPV irrigation system, WIPV pumping system, WIPV gas collection/power system, WIPV water delivery system, WIPV open water desalination plant, WIPV water treatment plant, WIPV Maritime Energy System, WIPV maritime mobile water desalination system, WIPV maritime national border defense system WIPV bridge, or WIPV water transportation system.

Non-limiting examples of photovoltaic cells that may be used to carry out the invention include, but are not limited to, advanced amorphous silicon photovoltaic modules, e.g., multi-junction amorphous silicon modules. For example, UNI-SOLAR brand silicon modules based on triple junction solar cells perform excellent under western European climatic conditions, with yields and performance ratios significantly higher than present crystalline silicon technologies. This effect is especially pronounced under low light conditions and under non-ideal orientations.

The triple junction technology provides unprecedented levels of efficiency and stability for amorphous silicon solar cells (stabilized aperture area cell efficiency of 7.0-7.5%). Each cell is composed of three semiconductor junctions stacked on top of each other. The bottom cell absorbs the red light, the middle cell the green/yellow light and the top cell absorbs the blue light. This spectrum splitting capability is one of the keys to higher efficiencies and higher energy output, especially at lower irradiation levels and under diffuse light. The cells are produced in a unique roll-to-roll vacuum deposition process on a continuous roll of stainless steel sheet, employing only a fraction of the materials and energy of the production of standard crystalline silicon solar cells. The result is a flexible, light weight solar cell. The solar cells are encapsulated in UV-stabilized and weather-resistant polymers. The polymer encapsulation includes EVA and the fluoro-polymer TEFZEL (a DuPont film) on the front side. The resulting modules are exceptionally durable. By-pass diodes are connected across each cell, allowing the modules to produce power even when partially shaded.

Regarding the tilt angle feature mentioned above, the best tilt angle for any photovoltaic array is the one that produces the highest annual energy output for that particular location. The primary reference point is the latitude but other factors are involved as well. The arc of the sun varies with time of year so, typically, the shallow tilt angles produce more energy in the summer months while the steeper angles produce more energy in the winter months. The best, fixed angle is the compromise between the extremes that allows for the greatest delivered energy on an annualized basis. Tilt angle is especially important with crystalline PV technology, which is much more sensitive to the angle of the incident light as well as dust and dirt accumulations than amorphous silicon PV. Azimuth, or deviation from True South, has a similar impact on energy production as with tilt angle. Optimum performance is typically obtained with the tilted array aligned with True South. Deviations from True South skew the peak output curves in the direction of the deviation (East or West of True South). Generally, the steeper the tilt angle, the greater the effect that the deviation from True South has on the annual energy output.

A method for financing WIPV systems is now described in accordance with an embodiment of the present invention.

The financial instrument is herein called an ASPN (Aquate Solar Performance Note), and is a type of asset-backed security (ABS). The primary purpose of the ASPN is to enable independent financing of the setup and operation of WIPV systems (e.g., WIPV power plants ranging in size from 1-100 MW and with an estimated total planned capacity in the range of 1000 MW and global potential for tens of thousands of megawatts.

In accordance with definitions taken from www.riskglossary.com, an ABS is a securitized interest in a pool of assets. Conceptually, the structure is similar to a mortgage-backed security (MBS), so it is convenient to describe the structure according to its differences from MBS.

MBSs are backed by mortgages-fixed rate, floating rate, residential, commercial, single family, multi-family, etc. ABSs are backed by non-mortgage assets. This includes auto loans, credit card receivables, home equity loans, student loans, etc. Due to government guarantees, MBSs typically entail no credit risk. ABSs generally lack such guarantees, so they entail credit risk. Due to diversification of the underlying assets, as well as credit enhancements, that risk tends to be modest. ABSs can be subject to prepayment risk, but this is slight compared to that of MBSs. ABSs are appealing to issuers because the structure allows them to get assets off their balance sheets, freeing up capital for further receivables. Also, ABSs make it possible for issuers whose unsecured debt is below investment grade to sell investment grade-even AAA-rated-debt.

To create an ABS, a corporation creates a special purpose vehicle to which it sells the assets. While it is common to speak of the corporation as the issuer of the ABS, legally, it is the trust or special purpose vehicle that is the issuer. It sells securities to investors. To protect investors from possible bankruptcy of the corporation, there are three legal safeguards:

a. Transfer of assets from the corporation is a non-recourse, true sale.

b. Investors receive a perfected interest in the assets' cash flows, that is, their claim in the assets' cash flow precedes any existing or future third-party claims in the event of bankruptcy. A perfected interest represents a lien on collateral.

c. A non-consolidation legal opinion is obtained certifying that assets of the trust or special purpose vehicle cannot be consolidated with the corporation's assets in the event of bankruptcy.

These same safeguards allow the corporation to remove the assets from its balance sheet. The corporation generally continues to service the assets—collecting interest and principal payments, pursuing delinquencies, etc. It is paid out of asset cash flows for providing these ongoing services.

For investors, ABSs are an alternative to highly-rated corporate debt. They generally offer similar or superior liquidity. Because the underlying assets are diversified, they are less subject to credit surprises. ABSs can be structured into different classes or tranches, much like collateralized mortgage obligations (CMOs). There may be senior or subordinated classes of debt, which have different credit ratings. Tranches may be structured with different average maturities. Choice of structure depends upon investor demand as well as the nature of the underlying assets.

ASPNs may be issued by the WIPV provider in conjunction with an ALOP (advanced loss of profit) insurance wrapper, e.g., provided by leading insurance companies, as a vehicle for raising financing (e.g., AAA investment grade debt financing) from commercial banks and other financial parties. ALOP insurance refers to the insurance of revenue from projects under construction. It is also known as DSU (delay in start-up) insurance.

This non-equity based financing method will enable the WIPV provider to become the owner of the assets following maturity of the ASPN's.

The advantages inherent with ASPN's based on WIPV are extremely fast project turnarounds (weeks vs. years) which in turn offset the start-up risks normally associated with large energy assets (power plants), as mentioned in the background of the invention. The method of the invention has synergistic advantages, because the apparent risk during the project setup period is reduced to a minimum, which reduces the insurance premiums, which in turn increases the profit margins.

The WIPV provider may also partner with leading investment bank firms (preferably specializing in green energy) for making ASPN bonds a tradeable security thus creating liquidity and additional profits.

Without limitation, ASPN's may include the following supporting documents:

1. The WIPV provider's exclusive option to cover a water surface area in return for energy derived

2. The WIPV provider's long-term (e.g., 20-30 years) product warranty on the material used to cover the body of water in the WIPV system (solar membrane material), and long-term (e.g., 20-30 years) power performance guarantee.

3. Long-term energy purchase contract (e.g., 10-30 years)

4. Performance guarantees/bonds for WIPV plant setup

5. Performance guarantees/bonds for WIPV plant maintenance

6. Disaster insurance

The solar membrane is an innovative material described in applicant's co-pending U.S. patent application 60/811439, filed 7 Jun. 2006, made by applying flexible roll to roll manufactured photovoltaic materials to geomembrane material for covering large water bodies. Geomembranes are geosynthetic materials used as liners and covers of water reservoirs and other types of environmental containment solutions.

It will be appreciated by persons skilled in the art that the present invention is not limited by what has been particularly shown and described hereinabove. Rather the scope of the present invention includes both combinations and subcombinations of the features described hereinabove as well as modifications and variations thereof which would occur to a person of skill in the art upon reading the foregoing description and which are not in the prior art.

What is claimed is:

1. A method for financing a provider of energy to a utility, the method comprising:
creating a financial instrument belonging to an energy provider, which comprises an asset-backed security (ABS), said ABS being backed by non-mortgage assets and said energy provider being part of a corporation,
issuing and selling the ABS to an investor; and
protecting the investor from possible bankruptcy of the energy provider by:
a. defining any transfer of assets from the energy provider as a non-recourse, true sale,
b. giving the investor a perfected interest in the asset cash flows of the energy provider, and
c. obtaining a non-consolidation legal opinion certifying that assets of the energy provider cannot be consolidated with assets of the corporation in the event of bankruptcy.

2. The method according to claim 1, further comprising issuing said financial instrument in conjunction with an ALOP (advanced loss of profit) insurance wrapper, which insures revenue from projects under construction.

3. The method according to claim 2, wherein said ALOP is provided by an insurance company.

4. The method according to claim 1, wherein said energy provider becomes owner of assets associated with said ABS following maturity of said financial instrument.

5. The method according to claim 1, further comprising said corporation removing assets associated with said ABS from a balance sheet of said corporation.

6. The method according to claim 1, further comprising said corporation servicing assets associated with said ABS, the servicing comprising at least one of collecting interest and collecting principal payments, and the servicing being funded by cash flows of the assets associated with said ABS.

7. A method for financing a provider of energy to a utility, the method comprising:
creating a financial instrument belonging to an energy provider, which comprises an asset-backed security (ABS), said ABS being backed by non-mortgage assets and said energy provider being part of a corporation,
issuing and selling the ABS to an investor; and
protecting the investor from possible bankruptcy of the energy provider by:
a. defining any transfer of assets from the energy provider as a non-recourse, true sale,
b. giving the investor a perfected interest in the asset cash flows of the energy provider, and
c. obtaining a non-consolidation legal opinion certifying that assets of the energy provider cannot be consolidated with assets of the corporation in the event of bankruptcy;
and wherein said energy provider comprises a provider of solar generated electricity that is generated by a WIPV (Water Integrated Photovoltaic) energy generating system, said energy provider being referred to as a WIPV provider.

8. The method according to claim 7, further comprising issuing said financial instrument in conjunction with an ALOP (advanced loss of profit) insurance wrapper, which insures revenue from projects under construction.

9. The method according to claim 8, wherein said ALOP is provided by an insurance company.

10. The method according to claim 7, wherein said WIPV provider becomes owner of assets associated with said ABS following maturity of said financial instrument.

11. The method according to claim 7, further comprising said corporation removing assets associated with said ABS from a balance sheet of said corporation.

12. The method according to claim 7, further comprising said corporation servicing assets associated with said ABS, the servicing comprising at least one of collecting interest and collecting principal payments, and the servicing being funded by cash flows of the assets associated with said ABS.

13. The method according to claim 7, wherein said financial instrument comprises an exclusive option for said WIPV provider to cover a water surface area in return for energy derived therefrom.

14. The method according to claim 7, wherein said WIPV provider provides a long-term product warranty on a material used to cover the water surface area.

15. The method according to claim 7, wherein said WIPV provider provides a long-term power performance guarantee.

16. The method according to claim 7, wherein said WIPV provider provides a long-term energy purchase contract.
